(19) United States
(12) Patent Application Publication
(10) Pub. No.: US 2007/0031152 A1
(43) Pub. Date: Feb. 8, 2007

(54) Optical wireless communications realignment

(75) Inventors: Tsvi (Henri) Eitane, Netanya (IL); Ran Manor, Tal-Shahar (IL); Ilan Haber, Bnei Brak (IL)

Correspondence Address: KATTEN MUCHIN ROSENMAN LLP, 575 MADISON AVENUE, NEW YORK, NY, 10022-2585, US

(73) Assignee: RAD-OP LIMITED

(21) Appl. No.: 11/196,587

(22) Filed: Aug. 3, 2005

(51) Int. Cl. H04B 10/00

(52) U.S. Cl. 398/131

(57) ABSTRACT

A method for maintaining high availability of an optical wireless data communications link including a first optical terminal and a second optical terminal undergoing free-space communications. A first signal modulated on a first optical carrier is transmitted from the second optical terminal to the first optical terminal. A second signal modulated on a second optical carrier is transmitted from the first optical terminal to the second optical terminal. A first received signal strength of the first signal is monitored and a second received signal strength of the second signal is monitored. Upon detecting the first received signal strength to be less than a previously determined value, the first received signal strength is provided upon request to the second optical terminal by switching off the second signal and encoding the first received signal strength as a second realignment signal onto the second optical carrier. The second optical terminal is realigned based on the second realignment signal.

### FIELD AND BACKGROUND OF THE INVENTION

The present invention relates to optical wireless communications and, more particularly, to a system and method for automatically realigning terminals undergoing optical communications. Specifically, the present invention relates to optical wireless communications systems appropriate for installation of point to point links between buildings for extending communications networks

On Jun. 3, 1880, Alexander Graham Bell transmitted the first wireless telephone message on his newly-invented “photophone” which transmits sound on a beam of light. In one experiment in Washington, D.C., Bell and his co-inventor Charles Sumner Tainter succeeded to communicate clearly over a distance of some 700 ft. (about 213 m), using plain sunlight as the light source.

Although the photophone was an extremely important invention, Bell's original photophone design suffers from the same difficulties as modern free space optics (FSO) or optical wireless communications technology. These difficulties particularly include geometric loss of signal and optical misalignment caused for instance by building movements or mechanical creep.

Geometric loss of signal occurs because the light beam is not perfectly collimated but diverges with a finite beam divergence, typically 2 mrad. Since the receiver aperture is practically limited to about 20 cm., the beam diameter at the receiver is 20 cm at a range of 100 meters and the beam diameter is 2 meters at a range of 1 km. (Estimates ignore the size of the beam as transmitted.) The received signal decreases by a factor proportional to the area of the receiver aperture divided by the area of the beam of the receiver, which at 1 km range is 0.01 or −20 db.

In theory, the limitation of geometric signal loss may be removed by further collimating the beam, to for instance 0.2 mrad. However, buildings sway over angles exceeding 1 mrad especially due to seasonal temperature changes or wind. Other mechanical limitations which disallow further beam collimation include mechanical tolerances and mechanical creep.

A related system parameter is receiver angular field of view. Field of view is the angle over which the receiver may move and still receive signal within the photodetector. Field of view is the size of the photodetector divided by the effective focal length of the receiver optical system. For a typical photodetector of dimension 0.1 mm and and a focal length of 10 cm the field of view is 1 mrad. Typically, in single system both the beam divergence and the field of view are of the same order of magnitude. The field of view is important to determine mechanical tolerances related to bore sighting the receive path with the transmit path.

A typical prior art optical wireless communications system is manually aligned preferably with two installers at each terminal. The installers manually rough align the terminals toward each other. After a minimal signal is received, for instance at the second terminal, the received signal strength is used, to re-align by angularly rotating the first terminal in both azimuthal and elevation angles. Similarly, the signal strength received at the first terminal is maximized by angularly rotating the second terminal. The users communicate with each other typically by wireless radio communications, e.g. cellular telephone, to perform the re-alignment.

After installing the optical wireless link, the terminals gradually fall out of alignment for instance because of mechanical creep or building movement over a period of months and the availability of the link decreases. When the prior art optical wireless system falls out of optimum alignment, re-alignment is preferably performed. In order to maintain alignment, without requiring periodic alignment by a one or two users or installers, auto-tracking systems of many different types have been developed.

A representative auto-tracking system is disclosed in U.S. patent application publication Ser. No. 2001/0141753 as follows: In each optical wireless terminal, the angle is determined at which the light beam is received, typically by using a four-quadrant detector or other position sensitive detector. After the reception angle is determined, the alignment is shifted using a motorized drive to correct for minimizing the reception angle. Using the method of U.S. patent publication Ser. No. 2004/0141753, the terminals align themselves independently without communicating control parameters between the terminals. U.S. patent application publication Ser. No. 2002/0080452 discloses a similar auto-tracking system in which the angle of the received beam is used to drive a actuators to drive a moving mirror in the optical system. U.S. patent application publication Ser. No. 2002/0080452 and U.S. patent publication Ser. No. 2004/0141753 are included by reference for all purposes as if entirely set forth herein.

Other auto-tracking methods which require exchange of information between the terminals have been disclosed by Lang et al. in U.S. Pat. No. 3,566,126 and more recently by Chan et al. in U.S. Pat. No. 6,504,634. These auto-tracking methods generally require an auxiliary communications channel, such as with the use of a separate frequency or time-domain channel. U.S. Pat. No. 6,504,634 is included by reference for all purposes as if entirely set forth herein.

In addition to re-alignment, prior art auto-tracking systems are typically designed to compensate at least in part for deleterious optical effects, i.e. scintillation which occurs over distances longer than about 500 meters. Auto-tracking systems add considerable cost and complexity to the optical point to point link and are therefore used primarily in “high-end” longer range systems. Expensive components, such as four quadrant detectors or cameras are often required. In some cases, mechanical components, e.g. motors or actuators are constantly operating and the components used must be of very high reliability and long lifetime. In other cases, a management, e.g. SNMP infrastructure is required which adds considerable cost which is not practical in a “low cost” link.

Auto-tracking systems often cause problems which would not otherwise occur without auto-tracking. At least one auto-tracking system tracked the sun rather than the signal of the other terminal. In some cases, especially when control communication between the terminals is not used, auto-tracking between the two terminals may go into “oscillation” with the first terminal re-aligning itself to a new position after the second terminal has re-aligned and the second terminal re-aligning itself after the first terminal has re-aligned. The solutions to the design problems associated auto-tracking systems significantly increase the cost of the system.

Consequently, “low end” short range systems do not have auto-tracking systems. In order to increase link availability and reliability a large beam divergence and field of view e.g. greater than ˜5 milliradians are often used.

There is thus a need for, and it would be highly advantageous to have a system and method of re-aligning a point to point optical wireless link allowing a “low end” link to have extended range without significantly adding cost and complexity as is required with use of prior art auto-tracking systems.

Reference: http://en.wikipedia.org/wiki/Photophone

### SUMMARY OF THE INVENTION

The term “characteristic” as used herein in the context of an optical receiver, refers to measurable quantity usable for re-alignment such as received signal strength and/or position information regarding received light relative to a detector.

According to the present invention there is provided an optical wireless communications system with a first optical terminal and a second optical terminal undergoing duplex free-space data communications. A first signal, modulated onto a first optical carrier is transmitted from the second optical terminal to the first optical terminal. A second signal, modulated onto a second optical carrier is transmitted from the first optical terminal to the second optical terminal. The system includes a first monitor mechanism of the first optical terminal which provides a first monitor of received signal strength of the first signal, and a first switch mechanism of the first optical terminal. A first realignment signal sent from the second optical terminal is sensed by the first optical terminal. The second signal modulated onto the second optical carrier is switched off by the first switch mechanism and the first monitor as modulated onto the first optical carrier is switched on to modulate the second optical carrier. Preferably, a second monitor mechanism of the second optical terminal provides a second monitor of received signal strength of the second signal, and a second switch mechanism, of the second optical terminal, which upon sensing a second realignment signal from the first optical terminal, switches off the first signal modulated onto the first optical carrier and switches on the second monitor as modulated onto the first optical carrier. Preferably, the first realignment signal provides the second monitor and the second realignment signal provides the first monitor. Preferably, a first processor connected to the first optical terminal, and the second monitor is connected as input to the first processor. The processor is programmed to trigger the sending of the second realignment signal to the second optical terminal when said first monitor is less than a first previously determined value. The first monitor is input to a second processor connected to the second optical terminal. The second processor is programmed to trigger sending the first realignment signal to the first optical terminal when the second monitor is less than a second previously determined value. Preferably, a first motor mechanism is connected to the first optical terminal solely for re-aligning the first optical terminal in the direction of the second optical terminal, and a second motor mechanism operatively connected to the second optical terminal solely for re-aligning the second optical terminal in the direction of the first optical terminal. The first motor mechanism is operated by the first processor based on the second monitor and the second motor mechanism is operated by the second processor based on the first monitor.

According to the present invention there is provided, a method for maintaining high availability of an optical wireless data communications link including a first optical terminal and a second optical terminal undergoing free-space communications. A first signal modulated on a first optical carrier is transmitted from the second optical terminal to the first optical terminal. A second signal modulated on a second optical carrier is transmitted from the first optical terminal to the second optical terminal. A first received signal strength of the first signal is monitored and a second received signal strength of the second signal is monitored. Upon detecting the first received signal strength to be less than a previously determined value, the first received signal strength is provided to the second optical terminal by switching off the second signal and encoding the first received signal strength as a second realignment signal onto the second optical carrier. The second optical terminal is realigned based on the second realignment signal. Preferably, upon receiving the second realignment signal, the first optical terminal continues to provide the second realignment signal solely upon requesting by the second optical terminal. Preferably, upon completing the realignment,

the second received signal strength is provided to the first optical terminal by switching off the first signal and encoding the second received signal strength as a first realignment signal onto the first optical carrier. Preferably, the first optical terminal is re-aligned in the direction of the second optical terminal based upon the second received signal strength; and the second optical terminal is re-aligned in the direction of the first optical terminal based upon the first received signal strength. Preferably, the re-alignment of both terminals is based upon both the first received signal strength and the second received signal strength. Preferably. the first re-aligning is performed by a first processor connected to the first optical terminal, based on the first realignment signal input to the first processor, and the second re-aligning is performed by a second processor connected to the second optical terminal based on the second realignment signal input to the second processor. Preferably, the second received signal strength is monitored and the first re-aligning is performed solely upon detecting the second received signal strength as less than a first previously determined threshold value. Preferably, the first received signal strength is monitored and the second re-aligning is performed solely upon detecting the first received signal strength as less than a second previously determined threshold value.

According to the present invention there is provided, a method for maintaining high availability of an optical wireless data communications link including a first optical terminal and a second optical terminal undergoing free-space communications. A first signal modulated on a first optical carrier is transmitted from the second optical terminal to the first optical terminal and a second signal modulated on a second optical carrier is transmitted from the first optical terminal to the second optical terminal. A first characteristic of the first terminal is monitored and a second characteristic of the second terminal is monitored. Upon the first characteristic indicative of less than a previously determined performance level, The first characteristic is provided to the second terminal by switching off the second signal and encoding said first characteristic as a second realignment signal onto the second optical carrier. Upon receiving said second realignment signal, the second characteristic is provided to the first optical terminal by switching off the first signal and encoding the second characteristic as a first realignment signal onto the first optical carrier. Preferably, the second terminal is realigned based on the first characteristic; and the first optical terminal is realigned based on the second characteristic. Preferably, realignment of the terminals is performed based both on the first and second characteristics.

### BRIEF DESCRIPTION OF THE DRAWINGS

The invention is herein described, by way of example only, with reference to the accompanying drawings, wherein:

FIG. 1 is a simplified drawing of an optical wireless communications terminal, according to an embodiment of the present invention; and

FIG. 2 is a flow drawing, according to an embodiment of the present invention, of a method for periodic realignment of an optical wireless link, according to an embodiment of the present invention.

### DESCRIPTION OF THE PREFERRED EMBODIMENTS

The present invention is of a system and method of realigning a point to point optical link as required to compensate for building movement and/or mechanical creep.

The principles and operation of a system and method of realigning, according to the present invention, may be better understood with reference to the drawings and the accompanying description.

It should be noted, that although the discussion herein relates to optical wireless point to point links of short range, typically with less than 1 km. distance between the terminals, the present invention may, by non-limiting example, alternatively be configured as well using optical links of longer range or other types of point to point links, e.g. microwave links.

Before explaining embodiments of the invention in detail, it is to be understood that the invention is not limited in its application to the details of design and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

By way of introduction, a principal intention of the present invention is to realign a point to point link only when the link performance falls below a previously determined minimum value. As long as the link is performing adequately, the realignment mechanism is not functioning, e.g motors are disabled. According to one embodiment of the present invention, the realignment is performed automatically, i.e. without human intervention. According to another embodiment of the present invention, the realignment is triggered by a user of the point to point link, and consequently a trained installer is not required. Another intention of the present invention is to achieve an installation easily with one person only, allowing alignment to the terminals without multiple trips back and forth between the two terminals.

Another intention of the present invention is to extend the range of an optical point to point link without significantly reducing link availability. A “low end” point to point link for instance with beam divergence (and field of view) of 5 mrad may occasionally fall out of alignment due to mechanical creep of the mount or due to building movements. Reducing beam divergence to e.g. 2 mrad may extend the range but is more susceptible to the creep and the building movements. Since mechanical creep and building movements are long term processes, the present invention successfully compensates for these by performing realignment on the order of once a week or once a month. Since the realignment requires typically a few seconds, overall link availability is greatly improved without the complexity of an active auto-tracking system. Furthermore, by performing realignment occasionally as required and not constantly, less wear occurs on mechanical parts and motors and mechanical parts of shorter lifetime may be used.

The realignment mechanism may be of any such mechanisms known in the art, such as gimbals on the terminal itself or on a steering mirror within the terminal.

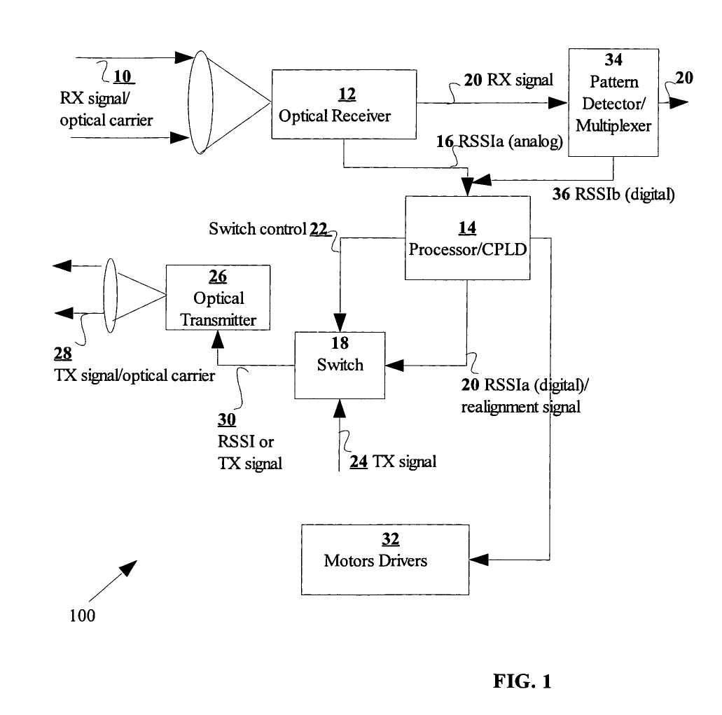

Referring now to the drawings, FIG. 1 is a simplified schematic drawing of an optical terminal 100 according to an embodiment of the present invention. An optical carrier carrying a received optical signal 10 is received by an optical receiver 12. Typically, optical receiver 12 includes a detector, e.g. avalanche photodiode, followed by a transimpedance amplifer and a post or limiting amplfier (components not shown). The post amplifier outputs a received signal 21. An analog received signal strength (RSSI) 16 is typically provided by commercial post amplifiers (e.g. MAX3748, Maxim Integrated Products, Inc. Sunnyvale, Calif.) used for optical receivers 12, Analog RSSIa 16 is input to an AID port of a microprocessor 14. Alternatively, or additionally a discrete A/D converter (not shown) is used in conjunction with a CPLD 14. In any case, analog RSSIa 16 is coded into a digital RSSIa with a specific pattern which is recognized by 34 pattern detector/multiplexer 34 as a realignment signal 20. Alternatively, realignment signal 20 initally includes a specific pattern indicating a low RSSI and subsequently after recognition and requested by other terminal 100, digital RSSIa will be coded onto realignment signal 20. Microprocessor 14 controls a switch 18 through a control line 22. Switch 18 is used to switch signal input 30 to an optical transmitter 26, either realignment signal 20 or TX signal 24. Optical transmitter 26 modulates either realignment signal 20 or TX signal 24 and transmits the modulated signal over transmitted optical carrier 28. Microprocessor 14 also controls motors drivers 32 which drive the motors (not shown) used for realigning terminal 100 in the direction of other terminal 100 (not shown).

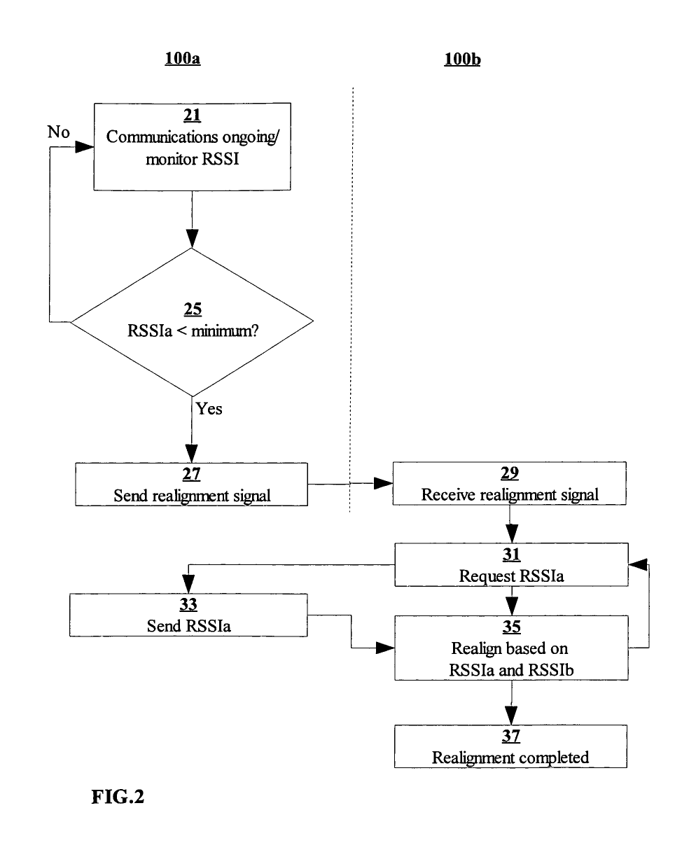

Reference is now made to FIG. 2 which illustrates the operation of terminals 100a and 100b in communication with each other during periodic realignment, according to an embodiment of the present invention. Terminals 100a and 100b are undergoing optical communications. During optical communications, terminals 100a and 100b are monitoring (step 21) RSSIa 16. If RSSIa 16 falls below a previously determined value (decision box 25), indicating, for instance a low bit error rate. (e.g. 10⁻¹⁰ bit errors per second), then terminal 100a sends (step 27) realignment signal 20 to terminal 100b. Terminal 100b detects (step 29) the pattern of realignment signal 20 and requests RSSIa 16 (step 31) from terminal 100a. Terminal 100b continues to request (step 31) RSSIa 16 as required and receives RSSIa (step 33) until realignment is completed (step 35). When a satisfactory alignment (step 35) is achieved, both units return to ongoing communications 21. Optionally terminal 100b after self-realignment termainal 100b sends (analogous to step 27) a realignment signal to 100a and terminal 100a performs realignment based on RSSIb according to the method of FIG. 2 but in reverse.

The realignment method, according to a preferred embodiment of the present invention is based simultaneously on both RSSI values.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

While the invention has been described with respect to a limited number of embodiments, it will be appreciated that many variations, modifications and other applications of the invention may be made.

What is claimed is:

1. An optical wireless communications system, wherein a first optical terminal and a second optical terminal undergoing duplex free-space data communications, wherein a first signal modulated onto a first optical carrier is transmitted from the second optical terminal to the first optical terminal and a second signal modulated onto a second optical carrier is transmitted from the first optical terminal to the second optical terminal, system comprising:
(a) a first monitor mechanism, of the first optical terminal, which provides a first monitor of received signal strength of said first signal; and
(b) a first switch mechanism, of the first optical terminal, which upon sensing a first realignment signal sent from the second optical terminal, switches off the second signal modulated onto the second optical carrier and switches on the first monitor as modulated onto the second optical carrier.

2. The system, according to claim 1, further comprising:
(c) a second monitor mechanism, of the second optical terminal, which provides a second monitor of received signal strength of said second signal;
(d) a second switch mechanism, of the second optical terminal, which upon sensing a second realignment signal from the first optical terminal, switches off the first signal modulated onto the first optical carrier and switches on the second monitor as modulated onto the first optical carrier.

3. The system, according to claim 2, wherein said first realignment signal provides said second monitor and said second realignment signal provides said first monitor.

4. The system, according to claim 2, further comprising:
(e) a first processor operatively connected to the first optical terminal, wherein said second monitor is operatively connected as input to said first processor, wherein said first processor is programmed to trigger sending said second realignment signal to the second optical terminal when said first monitor is less than a first previously determined value.
(f) a second processor operatively connected to the second optical terminal, wherein said first monitor is operatively connected as input to said second processor, wherein said second processor is programmed to trigger sending said first realignment signal to the first optical terminal when said second monitor is less than a second previously determined value.

5. The system, according to claim 4, further comprising:
(g) a first motor mechanism operatively connected to the first optical terminal solely for re-aligning the first optical terminal in the direction of the second optical terminal, and
(h) a second motor mechanism operatively connected to the second optical terminal solely for re-aligning the second optical terminal in the direction of the first optical terminal,
wherein said first motor mechanism is operated by said first processor based on said second monitor and wherein said second motor mechanism is operated by said second processor based on said first monitor.

6. A method for maintaining high availability of an optical wireless data communications link including a first optical terminal and a second optical terminal undergoing free-space communications wherein a first signal modulated on a first optical carrier is transmitted from the second optical terminal to the first optical terminal and a second signal modulated on a second optical carrier is transmitted from the first optical terminal to the second optical terminal, the method comprising the steps of:
(a) monitoring a first received signal strength of said first signal and monitoring a second received signal strength of said second signal;
(b) upon detecting said first received signal strength less than a previously determined value, providing said first received signal strength to the second optical terminal by switching off the second signal and encoding said first received signal strength as a second realignment signal onto the second optical carrier; and
(c) second realigning the second optical terminal based on said second realignment signal.

7. The method, according to claim 6, further comprising the step of:
(d) continuing to provide said second realignment signal solely upon requesting by the second optical terminal.

8. The method, according to claim 6, further comprising the step of
(d) upon completing said second realigning, providing said second received signal strength to the first optical terminal by switching off the first signal and encoding said second received signal strength as a first realignment signal onto the first optical carrier.

9. The method, according to claim 8, further comprising the step of:
(e) first re-aligning the first optical terminal in the direction of the second optical terminal based upon said second received signal strength; and
(f) second re-aligning the second optical terminal in the direction of the first optical terminal based upon said first received signal strength.

10. The method, according to claim 8, further comprising the step of:
(e) first re-aligning the first optical terminal in the direction of the second optical terminal based upon both said first received signal strength and said second received signal strength; and
(f) second re-aligning the second optical terminal in the direction of the first optical terminal based upon both said first received signal strength and said second received signal strength.

11. The method, according to claim 9, wherein:
said first re-aligning is performed by a first processor operatively connected to the first optical terminal, based on said first realignment signal input to said first processor, and
said second re-aligning is performed is performed by a second processor operatively connected to the second optical terminal based on said second realignment signal input to said second processor.

12. The method, according to claim 9, further comprising the steps of
(g) monitoring said second received signal strength, and
(h) performing said first re-aligning, solely upon detecting said second received signal strength as less than a first previously determined threshold value.

13. The method, according to claim 9, further comprising the steps of
(g) monitoring said first received signal strength, and
(h) performing said second re-aligning solely upon detecting said first received signal strength as less than a second previously determined threshold value.

14. A method for maintaining high availability of an optical wireless data communications link including a first optical terminal and a second optical terminal undergoing free-space communications wherein a first signal modulated on a first optical carrier is transmitted from the second optical terminal to the first optical terminal and a second signal modulated on a second optical carrier is transmitted from the first optical terminal to the second optical terminal, the method comprising the steps of:
(a) monitoring a first characteristic of said first terminal and monitoring a second characteristic of said second terminal;
(b) upon said first characteristic indicative of less than a previously determined performance, providing said first characteristic to the second terminal by switching off the second signal and encoding said first characteristic as a second realignment signal onto the second optical carrier; and
(c) upon receiving said second realignment signal, providing said second characteristic to the first optical terminal by switching off the first signal and encoding said second characteristic as a first realignment signal onto the first optical carrier.

15. The method, according to claim 14, further comprising the steps of:
(a) realigning the second terminal based on said first characteristic; and
(b) realigning the first optical terminal base on said second characteristic.

16. The method, according to claim 14, further comprising the steps of:
(a) realigning the second terminal based on both said first characteristic and said second characteristic; and
(b) realigning the first optical terminal base on both said first characteristic and said second characteristic
